(19) United States
(12) Patent Application Publication
(10) Pub. No.: US 2021/0241403 A1
(43) Pub. Date: Aug. 5, 2021

(54) System and Method for Assisting Contributors

(71) Applicant: PhilanthroCorp, Colorado Springs, CO (US)

(72) Inventors: Mark DeBiase, Colorado Springs, CO (US); Dave Keesling, Woodland Park, CO (US); Don H. Johnson, Huntsville, TX (US); Phillip Scott, Oak Island, NC (US)

(21) Appl. No.: 16/827,497

(22) Filed: Mar. 23, 2020

Related U.S. Application Data
(63) Continuation-in-part of application No. 14/997,885, filed on Jan. 18, 2016, now abandoned.
Application No. 14/997,885 is a continuation-in-part of application No. 12/316,954, filed on Dec. 16, 2008, now abandoned.
Application No. 12/316,954 is a continuation-in-part of application No. 11/522,159, filed on Sep. 18, 2006, now abandoned.

(51) Int. Cl. G06Q 50/18; G06Q 30/02; G06Q 40/06; G06F 16/958; H04L 29/06

(52) U.S. Cl. CPC G06Q 50/186; G06Q 30/0279; H04L 63/04; G06Q 40/06; G06F 16/958; G06Q 30/0201

(57) ABSTRACT

A management system for managing, streamlining and automating the process of obtaining contributions for philanthropic entities (e.g., charities and other non-profit organizations), wherein user friendly Internet based processes are provided to (potential and actual) contributors that substantially eases the burden on such contributors in, e.g., contributing to such entities via planned giving or estate planning. For each of the philanthropic entities, the management system automates and facilitates the marketing and estate planning aspects for obtaining contributions in a manner that is consistent with the avowed beliefs and/or values of the entity, and that provides potential and actual contributors with contacts to professionals that also share the beliefs and/or values of the entity.

### CROSS REFERENCE TO RELATED APPLICATION

The present application is a continuation-in-part of U.S. patent application Ser. No. 14/997,885, filed Jan. 18, 2016, which is a continuation-in-part of U.S. patent application Ser. No. 12/316,954, filed Dec. 16, 2008, which is a continuation-in-part of U.S. patent application Ser. No. 11/522,159 filed Sep. 18, 2006; the entire contents of these previous applications are fully incorporated herein by reference.

### RELATED FIELD OF THE INVENTION

The present disclosure describes a method and system for a user friendly, Internet based estate planning and planned giving tool available for a wide area network (Internet) for, e.g., non-profit organizations and their donors (more generally contributors herein), wherein the method and system may be driven at least partially by data indicative of a predetermined perspective consistent with the organization's values and operating procedures.

### BACKGROUND

There is a need for method and system for managing the effort of soliciting and obtaining contributions for philanthropic organizations or entities, and additionally for easing the effort required by contributors. The present disclosure describes such a method and system.

### SUMMARY OF THE INVENTION

The present disclosure is generally directed to a user-friendly web-based system and method which provides entities (particularly, non-profit entities) and their contributors (candidate or actual) therefor with presentations, materials, strategies, and other resources for allowing such entities and candidate contributors:
(a) To better understand and appreciate philanthropic endeavors, processes and techniques regarding philanthropic contributions (e.g., donations) and the reasons therefor;
(b) To provide educational materials and presentations regarding planned/scheduled contributions, tax matters related to contributions, wherein such materials can be generally applicable to a wide range of circumstance, as well as customized to a particular entity and/or contributor's circumstances;
(c) To provide software tools for assisting in, e.g., determining financial projections for contributors which may include modeling a contributor's financial circumstances through time, and/or providing representations of tangible physical objects that such an entity or a contributor may or may not be able to purchase or obtain given the contribution(s) made or not made;
(d) To provide a web-based estate plan organizer wherein contributors can confidentially input personal, financial information and receive advice regarding various estate planning ideas and/or scenarios;
(e) To provide contacts with professionals familiar with philanthropic matters; and in particular, provide access to and/or referrals from one or more social/professional networks of individuals and organizations to assist the (potential) contributors in their estate planning matters, wherein reduced fees may be charged to such contributors. In one embodiment, a network of attorneys may be provided that share, affirm or otherwise are well versed in issues related to philanthropic giving; and
(f) To provide any or all of the above information and materials in a manner that is consistent with a predetermined perspective of the (potential) contributor's values and/or with a predetermined perspective of the values and operating procedures of an organization or entity utilizing the method and system disclosed herein to solicit donations or contributions from (potential) contributors.

In one embodiment of the method and system of the present disclosure automated e-mail messages are provided to potential or actual donors (e.g., who have requested information) for a plurality of organizations or entities contracting or otherwise providing access to the philanthropic services disclosed herein. For each such organization or entity, the e-mail messages generated therefor may include graphics, logos and other information for identifying the organization or entity as well as hyperlinks to Internet services and information provided by an embodiment of the presently disclosed method and system. In particular, such e-mail messages provide potential or actual donors (collectively also identified as “contributors” herein) with information promoting seminars related to philanthropic giving, current tax advantages for giving opportunities and charitable estate planning. Moreover, such emails may be substantially automatically generated for combining, e.g., information provided by the organization or entity (e.g., specifically for a particular collection of emails to be transmitted on a specific date), information identifying the organization or entity (logos, etc.), philanthropic information and presentations customized to the organization or entity, and access to software tools for modeling and/or determining financial or life style projections related to philanthropic giving.

In one embodiment of the method and system of the present disclosure network seminars (e.g., webinars) are provided to inform participants about various estate planning and charitable giving matters. Participants of instances of such seminars may be provided with authorization information providing access to such seminars. Such seminars may provide information to assist contributors in their estate planning needs. Such seminars may be presented on one or more communication networks, e.g., the Internet, a phone network, a wireless network, or a combination of networks wherein presentation media from various networks are combined or synchronized to provide enhanced user (contributor) experiences. Accordingly, such seminars (more generally, “presentations”) may be tailored to the presentation capabilities of each presentation participant. Thus, participants may be provided with a version of a presentation that utilizes only audio communication, while other participants may be provided with a version of the presentation that utilizes audio plus a low (or erratic) visual presentation, e.g., via a low data rate Internet connection, while other participants may be provided with a version of the presentation that utilizes a high speed broadband Internet connection that in near real time supports two way network communication with such participants.

In one embodiment of the method and system of the present disclosure reports to contributors are automatically and/or periodically generated for distribution to the contributors of organizations or entities. Such reports may be of a financial nature and may be confidential to the contributor. Accordingly, a contributor may be utilizing the presently disclosed method and system for receiving such confidential information from a plurality of different or independent organizations or entities, such confidential information is disclosed selectively as specified by the contributor. Thus, the contributor may request all information relating to philanthropic contributions managed or accessed via the presently disclosed system and method (herein also identified as a “philanthropic management system”) be provided to him/herself, all information relating to a first collection of one or more philanthropic organizations or entities be provided to one or more specified individuals, and not providing any information related to the contributor's dealings with another second collection of one or more philanthropic organizations or entities. Moreover, the contributor's philanthropic related information across a plurality of charitable organizations or entities may be combined into a unified report for the contributor.

Additionally, a contributor may provide contribution rules or constraints to an embodiment of the present method so that changes in contribution amounts to various organizations or entities can be automatically implemented dependent upon, e.g., one or more of: (i) a total amount (or projected amount to be) in a trust fund, (ii) an amount of profit (or projected amount to be) made by such a trust, (iii) a yearly income received by a particular business, philanthropic organization or entity, or a particular individual, (iv) an age of a particular individual, (v) total maximum amount to be allocated for contributions, (vi) a priority or ranking of types of assets from which contributions are to be made. Thus, a contributor may specify rules such as the following rules:
(a) If charitable organization A's total net assets is greater than $1,000,000 then retain 5% of the contributor's annual contribution to A;
   Else if the charitable organization A's total annual income for each of two consecutive years is less than $500,000, then add an additional 5% to the contributor's annual payment from retained amounts, and cease all payments if in the third year organization A's total annual income is less than $500,000.
(b) If a charitable organization B increases the number of orphans being housed increases 5% in any one year, then increase the contribution to B by 3%.
(c) Cease (decrease or suspend) or commence (increase or re-commence) contributions to charitable organization C when a predetermined condition occurs, e.g., a particular individual reaches a certain age, contributor's total asset base falls below (rises above) a predetermined amount, the annual income of a particular person falls below (rises above) an inflation adjusted amount, the collective instructions from a predetermined group of individuals or entities, etc.

Accordingly, in one embodiment, the presently disclosed philanthropic management system may not only monitor a contributor's charitable or philanthropic giving, but also assist in the actual allocation of contributions according to, potentially complex, rules or instructions provided by the contributor. Additionally/alternatively, it is within the scope of the present disclosure that contributors may have access to financial tools for modeling their contributions into the future according to such rules, wherein, e.g., various scenarios may be generated by the philanthropic management system disclosed herein. In particular, such scenarios may be substantially more complex than merely assuming certain annual return rates of various asset types. For example, such scenarios may take into account historical information about what is likely to be the result on a given one or more charities (or types thereof) of an economic downturn in, e.g., the global (or a national) economy. Thus, the contributor may enter rules that try to balance competing needs for the contributor's contributions, wherein a balance may depend on both the likely economic health of one or more charitable organizations as well as the contributor's assets. Moreover, statistical (Markov) simulations may be performed providing contributors with information about likely outcomes such as when a trust fund would be likely to be depleted, under what circumstance would contributions to health related charities exceed contributions to drug addiction prevention related charities assuming economic fluctuations in the future can be approximated by economic fluctuations in the past.

In one embodiment of the philanthropic management system of the present disclosure provides training and/or configuration assistance for non-profit clients (e.g., charitable organizations and entities) and their staff via network (Internet) communications. In particular, such training or assistance may assist such staff in profiling various types of contributors according to various characteristics, e.g., a geographical area(s) contributors reside, or contributor charitable giving history, or demographic group(s) such as: age group(s), income level group(s), educational level group(s), organization affiliation(s). Such profiling can be used to identify additional prospective contributors to a charitable organization or entity.

In one embodiment of the philanthropic management system of the present disclosure charitable organizations or entities may also be profiled for assisting contributors in diversifying their contributions over a plurality of such organizations or entities. For example, a contributor (advisor thereto) that has accessed the presently disclosed philanthropic management system for investigating contributing to a particular charity or non-profit organization may be provided with access to one or more of the following:
(a) Access to the identification of other philanthropic organizations or entities that other contributors to the particular charity or non-profit also contribute;
(b) Contribution diversification or allocation information aggregately collected from other contributors having similar contributor profiles and/or interests;
(c) Ratings of the performance of philanthropic organizations or entities, wherein such ratings are provided by the contributors thereto;
(d) Access to an “intelligent” search engine(s) allowing a contributor to search for prospective philanthropic organizations or entities that may be of interest to the contributor, wherein, e.g., the contributor need not necessarily enter explicitly for such a search the information used by the engine(s), and the results may include information describing why each resulting philanthropic organization or entity is presented to the contributor.

In one embodiment of the philanthropic management system of the present disclosure, downloadable, customizable marketing materials may be provided to non-profit entity clients. Such materials may cover various topics pertinent to charitable giving, tax planning and estate planning.

In one embodiment of the philanthropic management system of the present disclosure, this management system may be branded for private-label of various client philanthropic organizations or entities. Such branding may be integrated into each such client's corresponding website.

In one embodiment of the philanthropic management system of the present disclosure professional advisors for facilitating/enabling planned contributions may also be profiled for assisting contributors in providing contributions. For example, a contributor may access the presently disclosed philanthropic management system for investigating such advisor(s) may be provided with access to one or more of the following:
(a) Access to the identification of such advisors that other contributors have used;
(b) Information on advisor preferences aggregately collected from other contributors having similar contributor profiles and/or interests;
(c) Ratings of the performance of such advisors, wherein such ratings are provided by the contributors that used such advisors; and
(d) Access to an “intelligent” search engine(s) allowing a contributor to search for prospective advisors that may be of interest to the contributor, wherein, e.g., the contributor need not necessarily enter explicitly for such a search the information used by the engine(s), and the results may include information describing why each resulting advisor identified is presented to the contributor.

In one embodiment of the philanthropic management system of the present disclosure, an on-line, interactive, estate planning interactive guide (also referred to as an “estate planning agent”) which contributors can utilize to assist in (preparing for) drafting estate planning documents. This web-based interactive planning guide can take contributors (or other users) step by step through an estate planning process, wherein a result therefrom may be: (i) initial drafts of certain documents and/or the information necessary for having such final documents drafted by a professional such as an estate planner or attorney. Such documents may include wills, revocable living trusts, bypass trusts, testamentary charitable remainder trusts, and children's trusts, etc. Note that the philanthropic management system may be used for securely submitting such initial document preparation information to one or more advisors, e.g., for allowing the contributor to obtain an initial consultation with the advisors, and for obtaining fee estimates. Such submissions may be conveyed electronically via the Internet.

In one embodiment of the philanthropic management system of the present disclosure a preferred collection of attorneys and/or other professionals may be accessed by the management system for selecting prospective professionals to be identified to a contributor. The selected prospective professionals may be selected according to their geographic proximity to the contributor (e.g., in a same city or metropolitan region as the contributor resides), fee structure for preparing estate planning and charitable contribution documents, special expertise of the professional, etc.

In one embodiment of the philanthropic management system of the present disclosure “belief” based in that the beliefs of the contributors and advisors are taken into account in identifying, selecting and determining how best to assist contributors in estate planning and charitable giving. In particular, for a client philanthropic organization utilizing a belief-based philanthropic management system, such a management system may be characterized by:
(a) Determining, storing and providing documents and other information to contributors for the client philanthropic organization, wherein the documents and other information are at least consistent with (and preferably bolsters) the client philanthropic organization's beliefs and/or values relating to situations, circumstances and/or events that occur beyond the lifetime of the contributor (in particular, as such information relates to philanthropic giving). The stored documents and other information is accessible for transmittal to contributors on a communications network (e.g., the Internet);
(b) Providing interactive network (Internet) communications between the client philanthropic organization or entity and one or more contributors for determining a financial or economic impact on each such contributor, wherein a quantitative financial or economic projection is provided to the contributor prior to the contributor consenting to a particular contribution, the projection showing a net negative financial or economic impact to the contributor and optionally his/her successors, and wherein the projection is based on financial or economic data;
(c) Selecting and/or providing to the contributors contacts for professionals and/or other individuals with expertise relating to, e.g., scheduled or planned contributions via estate planning and legal issues related thereto, wherein such selected individuals have beliefs and/or values about situations, circumstances and/or events that occur beyond the lifetime of such individuals that are at least consistent with (and preferably bolsters) the client philanthropic organization's beliefs and/or values relating to situations, circumstances and/or events that occur beyond the lifetimes of individuals identified with the philanthropic entity and beyond the lifetimes of the professionals;
(d) Filtering or deselecting professional contacts of individuals or entities having beliefs about situations, circumstances and/or events that occur beyond the lifetime of such individuals or entities that are at least inconsistent with the philanthropic organization's beliefs and/or values relating to situations, circumstances and/or events as described in (a) immediately above; and
(e) Restricting, filtering and/or precluding the providing of documents, information, and contacts for individuals that expressly state or otherwise have advocated acts that are inconsistent with the philanthropic organization's beliefs and/or values relating to situations, circumstances and/or events that occur beyond the lifetimes of individuals identified with and attesting to beliefs and/or values of the philanthropic entity.

Such belief-based features of the philanthropic management system are believed to be of particular interest to philanthropic organizations or entities, contributors, and advisors since it is believed that charitable giving is more belief driven than other financial exchanges.

In one embodiment of the philanthropic management system of the present disclosure, a preferred collection of attorneys and/or other professionals may be accessed by the management system for selecting prospective professionals to be identified to a contributor. The collection attorneys and/or other professionals may be selected for a particular client based on the values and beliefs of the contributor.

In one embodiment of the philanthropic management system of the present disclosure, legal services to clients' contributors may be provided with reduced legal rates. Such legal services are at no cost to the client.

In one embodiment of the philanthropic management system of the present disclosure, both the client philanthropic organizations and their contributors register with the management system for providing authenticated secure Internet communications.

In one embodiment of the philanthropic management system of the present disclosure, a turn-key charitable gift annuity system (including implementation and maintenance) is provided at no cost or reduced cost to a client philanthropic organization. For example, an operator of the philanthropic management system may receive compensation from the funding received from contributors to the client philanthropic organization, wherein such contributors utilized the management system. Alternatively/additionally, compensation to the operator of the philanthropic management system may receive a percentage of the annual income stream received from contributors to the client philanthropic organization, wherein such contributors utilized the management system.

The presently disclosed philanthropic management system is particularly beneficial for philanthropic entities or organizations that cannot afford the overhead of hiring one or more marketing and/or contributor care professionals. Since the management system disclosed herein provides common or similar services and materials to a potentially large number of philanthropic entities or organizations, much of the services and materials provided to clients can be based on generic services and materials that can be transformed into services and materials uniquely identified with each individual client. Such transformations are an important aspect of the functionality of the present management system.

Additionally, the presently disclosed philanthropic management system is particularly beneficial to philanthropic entities or organizations that have a very large number of contributors (e.g., 500,000) since it is financially infeasible for such an entity or organization to effectively communicate with such a large number of contributors for soliciting contributions of a potentially complex nature such as planned giving via, e.g., estate planning. Accordingly, since the transforming of generic marketing materials related to planned giving and reasons therefor can be spread over a plurality of philanthropic entities or organizations, the present management system is particularly cost effective for philanthropic entities or organizations with large numbers of contributors, particularly since charges for use of present management system to a philanthropic entity or organization may be substantially (or entirely) independent of the number contributors to the entity or organization.

Any combination of the above-identified aspects of the philanthropic management system identified above can be provided in an embodiment of such a system. Other features and benefits of the present disclosure are described in the accompanying figures together with the description hereinbelow. In particular, various features and/or embodiments of the philanthropic management system are set forth in the attached figures and in the description hereinbelow as described in the claims hereinbelow. Accordingly, it should be understood that this Summary does not contain all of the aspects and embodiments of the novelty disclosed herein. Thus, this Summary is not meant to be limiting or restrictive in any manner. Further, the invention(s) as disclosed herein is/are to be understood by those of ordinary skill in the art to encompass obvious improvements and modifications thereto.

### BRIEF DESCRIPTION OF THE DRAWINGS

The Figures described below are a small portion of the website for an embodiment of the philanthropic management system of the present disclosure. Note that PCX in the figures is the name of philanthropic management system disclosed in the figures.

FIGS. 1-2 illustrate pages from a website for an estate planning organizer according to an exemplary embodiment.

FIG. 3 illustrates an exemplary output that the estate planning organizer may present to the user regarding before and after the estate planning organizer plans with tax considerations according to an exemplary embodiment.

### DETAILED DESCRIPTION OF THE INVENTION

The definitions to the terms below are provided for convenience in understanding and do not serve to limit the scope or the general usage of these terms. In general, the terms below are also referenced in various portions of this document, of which those portions of this document may expand upon the definitions to the terms as given below.

“Clients” referred to in this application are philanthropic organizations or entities (e.g., charities or non-profit organizations) seeking to raise funds from among its contributors (i.e., current donors and prospective new donors).

“Contributors” referred to in the present disclosure are individuals who have made or will make charitable contributions to a philanthropic organization or entity of their choice.

“Webinar” referred to in the present disclosure is a seminar conducted via a website for the philanthropic management system, which includes interactive features as well as pre-recorded material.

The phrases “at least one,” “one or more,” and “and/or” refer to open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module,” refers to any known or later developed hardware, software, firmware, artificial intelligence, fuzzy logic, or combination of hardware and software that is capable of performing the functionality associated with that element.

The terms “determine,” “calculate,” and “compute,” and variations thereof are used interchangeably and include any type of methodology, process, mathematical operation or technique.

It shall be understood that the term “means” shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Embodiments herein presented are not exhaustive, and further embodiments may be now known or later derived by one skilled in the art.

Functional units described in this specification and figures may be labeled as modules or outputs in order to more particularly emphasize their structural features. A module and/or output may be implemented as hardware, e.g., comprising circuits, gate arrays, off-the-shelf semiconductors such as logic chips, transistors, or other discrete components. They may be fabricated with Very-large-scale integration (VLSI) techniques. A module and/or output may also be implemented in programmable hardware such as field programmable gate arrays, programmable array logic, programmable logic devices or the like. Modules may also be implemented in software for execution by various types of processors. In addition, the modules may be implemented as a combination of hardware and software in one embodiment.

An identified module of programmable or executable code may, for instance, include one or more physical or logical blocks of computer instructions that may, for instance, be organized as an object, procedure, or function. Components of a module need not necessarily be physically located together but may include disparate instructions stored in different locations which, when joined logically together, include the module and achieve the stated function for the module. The different locations may be performed on a network, device, server, and combinations of one or more of the same. A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

In one embodiment, the system, components and/or modules discussed herein may include one or more of the following: a server or other computing system including a processor for processing digital data, memory coupled to the processor for storing digital data, an input digitizer coupled to the processor for inputting digital data, an application program stored in one or more machine data memories and accessible by the processor for directing processing of digital data by the processor, a display device coupled to the processor and memory for displaying information derived from digital data processed by the processor, and a plurality of databases or data management systems.

In one embodiment, functional block components, screen shots, user interaction descriptions, optional selections, various processing steps, and the like are implemented with the system. It should be appreciated that such descriptions may be realized by any number of hardware and/or software components configured to perform the functions described. Accordingly, to implement such descriptions, various integrated circuit components, e.g., memory elements, processing elements, logic elements, look-up tables, input-output devices, displays and the like may be used, which may carry out a variety of functions under the control of one or more microprocessors or other control devices.

In one embodiment, software elements may be implemented with any programming, scripting language, and/or software development environment, e.g., Fortran, C, C++, C#, COBOL, Apache Tomcat, Spring Roo, Web Logic, Web Sphere, assembler, PERL, Visual Basic, SQL, SQL Stored Procedures, AJAX, extensible markup language (XML), Flex, Flash, Java, .Net and the like. Moreover, the various functionality in the embodiments may be implemented with any combination of data structures, objects, processes, routines or other programming elements.

In one embodiment, any number of conventional techniques for data transmission, signaling, data processing, network control, and the like as one skilled in the art will understand may be used. Further, detection or prevention of security issues using various techniques known in the art, e.g., encryption, may also be used in embodiments of the invention. Additionally, many of the functional units and/or modules, e.g., shown in the figures, may be described as being “in communication” with other functional units and/or modules. Being “in communication” refers to any manner and/or way in which functional units and/or modules, such as, but not limited to, input/output devices, computers, laptop computers, PDAs, mobile devices, smart phones, modules, and other types of hardware and/or software may be in communication with each other. Some non-limiting examples include communicating, sending and/or receiving data via a network, a wireless network, software, instructions, circuitry, phone lines, Internet lines, fiber optic lines, satellite signals, electric signals, electrical and magnetic fields and/or pulses, and/or the like and combinations of the same.

By way of example, communication among the users, subscribers and/or server in accordance with embodiments of the invention may be accomplished through any suitable communication channels, such as, for example, a telephone network, an extranet, an intranet, the Internet, cloud based communication, point of interaction devices (point of sale device, personal digital assistant, cellular phone, kiosk, and the like), online communications, off-line communications, wireless communications, RF communications, cellular communications, Wi-Fi communications, transponder communications, local area network (LAN) communications, wide area network (WAN) communications, networked or linked devices and/or the like. Moreover, although embodiments of the invention may be implemented with TCP/IP communications protocols, other techniques of communication may also be implemented using IEEE protocols, IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein.

In embodiments of the invention, the system provides and/or receives a communication or notification via the communication system to or from an end user. The communication is typically sent over a network, e.g., a communication network. The network may utilize one or more of a plurality of wireless communication standards, protocols or wireless interfaces (including LTE, CDMA, WCDMA, TDMA, UMTS, GSM, GPRS, OFDMA, WiMAX, FLO TV, Mobile DTV, WLAN, and Bluetooth technologies), and may be provided across multiple wireless network service providers. The system may be used with any mobile communication device service (e.g., texting, voice calls, games, videos, Internet access, online books, etc.), SMS, MMS, email, mobile, land phone, tablet, smartphone, television, vibrotactile glove, voice carry over, video phone, pager, relay service, teletypewriter, and/or GPS and combinations of the same.

Embodiment includes a web-based system to educate, motivate and empower individual contributors to make charitable gifts to philanthropic organizations or entities having similar beliefs and/or values as described in the Summary section hereinabove.

In one embodiment of philanthropic management system, all information, presentations and advisor contacts are based on Judeo-Christian beliefs and/or values as related to situations, circumstances and/or events that occur beyond the lifetimes of individuals identified with the philanthropic entity. However, other beliefs and/or values are also within the scope of the present disclosure. For example, an embodiment of the philanthropic management system may also assist philanthropic organizations or entities in obtaining contributions, wherein such an organization or entity may be directed to environmental issues, and accordingly hold and espouse beliefs and/or values as related to situations, circumstances and/or events that relate, e.g., to reducing the effects of manmade climate changes occurring both now and beyond the lifetimes of individuals identified with the philanthropic entity, and/or saving endangered species.

In one embodiment, the philanthropic management system has various Internet interfaces. A first such interface is for accessing a primary website that is accessible by the general population of Internet users, but is primarily intended for the clients of the management system, wherein clients (e.g., philanthropic entities or organizations) can access materials for marketing giving plans to contributors.

For each client philanthropic entity subscribing to the services offered by the philanthropic management system, an additional interface is available for the contributors to the philanthropic entity. Each such additional interface is tailored to identify the client, the client's unique logo, etc.

When a contributor and/or client subscribes to (or registers for) the services of the philanthropic management system, such subscribers have access to study courses, online seminars, up to date web-based information, marketing materials, legal professionals and more.

Once a client subscribes to the services of the philanthropic management system, the website therefor can be tailored to that client, using their logos and slogans, and generally looking like a part of the client's website. The tailor-made website is then linked into the client's website for seamless navigation by the client's contributors.

When a client's contributors are navigating the client's website, they can link to an embodiment of the philanthropic management system, including an Estate Plan Organizer, which they can fill out in private, send securely to philanthropic management system, who can then contact them with options for a successful estate plan. Other links from the client website may include an overview of estate planning issues, a client perspective of stewardship, gift opportunities, case studies, and general statistics and ideas from other “real life” contributors. Contributors are also given the opportunity to seek the assistance of an attorney from a preferred network of attorneys (at a reduced fee). This network of attorneys may utilize the services of a third-party company. This network of attorneys providing local legal advice to contributors is an important aspect that heretofore prevented or inhibited clients from getting their contributors from the stage of intending to make a client contribution to fully executing a charitable gift plan.

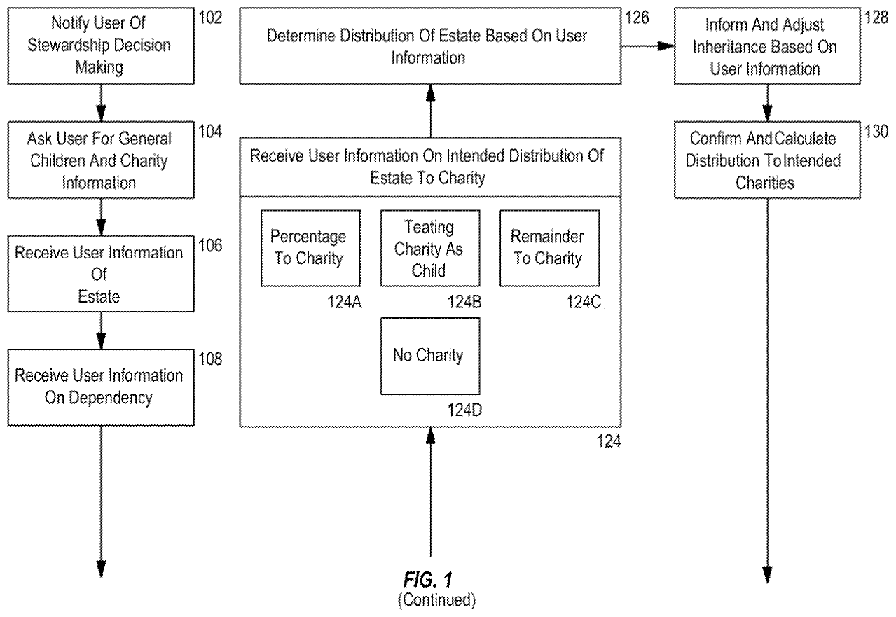

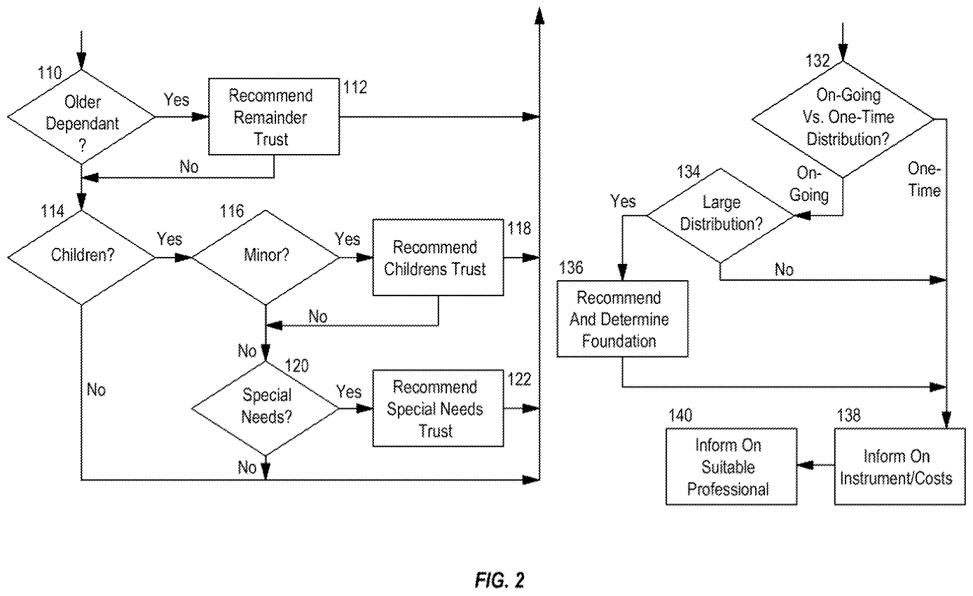

FIGS. 1-2 illustrate a flow diagram for an estate planning organizer according to an exemplary embodiment.

In an embodiment, the estate plan organizer is put together and organized in accordance with the teachings of the Bible. Organized through a study of the Bible with an understanding of the responsibility of stewardship and put together to comport with the rules of modern estate planning, the estate plan organizer offers a novel and beneficial method and system for anticipating and planning the disposal of an estate for a Christian.

In one aspect, the estate plan organizer reminds users that God is the owner of all of our resources, that we are merely stewards. Consequently, the largest stewardship decision we will ever make will be through an estate plan. As such, in estate planning in accordance to the Bible, we are merely arranging to transfer stewardship responsibly, hopefully in a way that would please the One who is created and owns all things. He said in Psalm 50: 10-12,
for every animal of the forest is mine, and the cattle on a Thousand Hills. I know every bird in the mountains, and in the creatures of the field are mine. If I were hungry I would not tell you, for the world is mine, and all that is in it.

According to an embodiment, the estate plan organizer comports to two overriding Biblical principles that are relayed in the estate plan organizer to guide people to wisely steward their estates. The first is dependency. As stated in 2 Timothy 5:8, we are “worse than an infidel if we fail to take care of those in the household of faith.” Thus, the first priority in transferring ownership is to take care of all dependents. The second overriding consideration is love, as Christians are called to love our neighbor as ourselves and be generous with what God has entrusted to us. As Jesus stated in Matthew 25:34-40,
Then the king will say to those on his right, ‘Come you who are blessed by my Father. Inherit the kingdom prepared for you from the foundation of the world. For I was hungry and you gave me food, I was thirsty and you gave me drink, a stranger and you welcomed me, naked and you clothed me, ill and you cared for me, in prison and you visited me’. Then the righteous will answer him and say ‘Lord, when did we see you hungry and feed you, or thirsty and give you drink? When did we see you a stranger and welcome you, or naked and clothe you? When did we see you ill or in prison, and visit you?’ And the king will say to them in reply ‘Amen, I say to you, whatever you did for one of these least brothers of mine, you did for me.’
   The estate plan organizer utilizes at least these two principles, dependency and love, to guide people in making these important estate distribution decisions.

The estate planning organizer begins with notifying the user of the stewardship decision making in step 102. This may serve as a remainder to users that God owns all resources and that these stewardship decisions are not ownership decisions as explained above in accordance with the Bible. Further, the users are reminded of the dependency and love criteria as explained above.

The estate planning organizer asks user for general children and charity information in step 104. Here, the estate planning organizer may ask information about the user's children (e.g., ages, personal situation such as marital status, etc.). Here, the estate planning organizer also reminds the user that his first responsibility is to care for dependents and particularly for a permanent dependency such as evidenced with a special-needs child.

To take users through this journey of stewarding their estates, early in the estate planning organizer right after asking about the user's children, the user is strategically asked about charities that the user supports. Here, the estate planning organizer also reminds the user that the charities that he supports and loves have also become dependent upon support and are worthy beneficiaries through the user's estate. By coupling the two: children and charities, the probability that the user will realize that it makes sense to designate a gift to charity through his estate is greatly increased.

The estate planning organizer receives user information regarding the estate in step 106. This may include various questions regarding the estate to determine the estate value and composition.

In an embodiment, when the user's assets include one or more businesses operated by the user and/or other business interests owned by the user, the estate planning organizer may ask further questions relevant to the businesses, in order to determine whether business succession planning is in place and to ascertain whether the user's estate receives any value from the businesses. If the planning is not in place, and the business may be subject to a distress sale or liquidation, the estate planning organizer may determine the issue to be a problem, and may notify the user and/or offer referrals to professionals with knowledge in their respective profession as well as knowledge consistent with the philanthropic belief and/or cause (e.g., professionals with faith-based, e.g., Christian, knowledge) that can provide solutions. Depending on the circumstances, these solutions may be in the form of buy-sell agreements involving insurance policies, transition arrangements with other employees, resources to help position for a sale of the business or other solutions.

For example, if a user's estate includes such a business (e.g., a business run by the user), the estate planning organizer may ask a series of questions to see if business succession planning is in place, and to assess what would happen to the business if the user were to suddenly not be able to run the business anymore. From these questions the estate planning organizer may be able to discern contingencies, such as if there are other key employees that could run the business in the absence of the user, which may prevent circumstances such as any distressed sale. Further, if these individuals or an individual exists, and particularly if any of these individuals are significantly younger than the user, the estate planning organizer may proceed to ask questions about the user's insurability. If insurable, the estate planning organizer may point a user to professionals specializing in buy/sell and other various insurance solution.

Even if insurance is not a possibility, if the businesses have key employees and/or other persons that can carry on the work of the businesses, the estate planning organizer may point the user to providers that could help with transition agreements with these employees and/or other persons (e.g., to purchase the stock at user's death or retirement). If none of these options are possible, the estate planning organizer may point the user to a business broker or other professionals for sale and/or disposition of the user's interest in the business either at present or down the road, to ensure that the user eventually manage an orderly disposition of the business (e.g., obtains a good value for the business, etc.). Further, the estate planning organizer may point the user to a business consultant who may help the user develop employees and/or other persons that could carry on the business and/or create better business transition options.

The estate planning organizer receives user information regarding the dependency 108. This may include all types of dependents including older dependents (e.g., parents, siblings) and children.

For all dependents, whether older (e.g., parents) or younger (e.g., children), the estate planning organizer may run calculations to confirm that assets are sufficient to take care of the dependents. The calculations may take into account ages of children, and life expectancy of older dependents. In addition, if asset values include a business that would be subject to a distress sale or liquidation, business values may be adjusted for this calculation. If a shortfall exists, the estate planning organizer may quantify the shortfall and alert the user. The estate planning organization may provide the respective philanthropic, religious, and/or other financial planners proficient and/or compatible with the user's belief (e.g., Christian beliefs) that can assist to obtain the needed financial vehicles (e.g., life insurance). Further, the estate planning organizer may also provide directed options for providing the financial vehicles (e.g., customized hyperlinks or other transfer mechanisms to contact the preferred providers or apply for the financial vehicles online, including the transfer of information using pre-filled forms, user information exchange, and/or other information exchange mechanisms as known now or may be later derived).

For example, in the case of life insurance, the estate planning organizer may make calculations based on the user's information (including information regarding the user's assets) to ensure sufficient funds are available for depends.

### Example Calculation

First, if the user has children under the age of 22, the remaining cost to raise the user's children can be estimated using the USDA average cost through college (e.g., $332,050). The remaining cost may be calculated for each child, based on the following Formula 1, utilizing each child's age.

cost through college*(22−(child's present age))/22 (Formula 1)

Here, the remaining cost for a child age 10 would be:

$332,050*(22−10)/22=$181,118

The cost is compiled for each child based on age, and total (a) for all children is compiled.

Next, if the user has older/adult dependents, the present annual cost is first estimated. To do this, the user is encouraged to monetize the time involved for any care personally provided at present. Afterwards, the user may be prompted to add to this allotment if increased care is anticipated in the near future. The total remaining cost of the care (b) is estimated using the following Formula 2.

(Present Annual Cost with above adjustments)*(Remaining life expectancy in years of dependent from actuarial tables)*(1.5 Contingency Factor for longer life/increasing level of care) (Formula 2)

This calculation is repeated for all older/adult dependents.

Finally, the total proceeds available from the user's estate (c) may be calculated, as if the user were to die tomorrow, and not be able to take care of any dependents. As such, all life insurance proceeds are included in this calculation, except any employer provided insurance, as this is tied to particular employment, making the term unknown. Values of user owned and operated businesses are excluded from this calculation unless business succession planning is in place, and there is confidence that the estate will realize a benefit from the business.

If a+b−c is positive, the organizer may alert the user of the shortfall, and provide referrals to compatible insurance providers that can help.

If a+b−c is negative, but insurance is included in the calculation that has a term shorter than the above time span of dependency, then the calculation is repeated at the time horizon of each term insurance. If at the expiration of any term insurance, (a+b−c) is positive, the organizer may alert the user, and provide referrals to compatible insurance providers who can help.

For older dependents 110, if the user will need to prepare for older dependents, the estate planning organizer may recommend a charitable remainder trust for these dependents to provide income for life at a desired level (e.g., with an inflation hedge) 112.

For children 114, if the user has children, the estate planning organizer may consider if the child is a minor 116 or has special needs 120. If the child is a minor 116, the estate planning organizer may recommend a children's trust to hold assets for the child until the child reaches a desired age (e.g., an age of financial maturity) and then distribute assets to beneficiaries or charities. If the child has special needs (e.g., have serious health issues that likely require long term assistance), the estate planning organizer may recommend a special needs trust for the child. Further, the special needs trust may be arranged to have all assets allocated to it is the need is great or uncertain enough. As such, the estate planning organizer may recommend to exclude any charitable distribution from plan and recommend distribution of reserving assets for special need.

It is noted that a user may have multiple dependents or no dependents based on the situation of each user.

Once the user has planned for his dependents and decides to give through their estate, the estate planning organizer can help the user to decide how much to give to charity. The estate planning organizer mentions a tithe (10%) just because this is a very familiar Biblical concept. The estate planning organizer may also steer the user towards the concept of another child called “charity” again reminding them that the charities that they have loved and supported have become somewhat dependent. Here, a family with three children would carve the estate into four equal parts, giving each of the children 25% of the estate, and dividing the remaining 25% among the ministries they want to benefit.

Also, higher net worth individuals may typically conclude that leaving too much to their children can be harmful rather than helpful, preventing them from developing good work habits and a reliance on God rather than material possessions. Upon reflection of Genesis 3:19, “by the sweat of your brow you shall eat bread,” these individuals will often decide to cap the children's inheritance and leave the balance to the charitable organizations that they care about.

The estate planning organizer receives user information regarding intended distribution of estate to charity in step 124. Here, the user may decide to give a percentage to charity (e.g., similar to a tithe amount of 10%) 124A, treating charity as a child 124B, distributing a fixed amount to heirs, and/or passing the remainder to charity 124C or no distribution to charity (e.g., all assets are distributed to children and/or family) 124D.

The estate planning organizer may ensure that instructions are clearly given to fund any charitable gifts first through specific tax encumbered assets (such as tax deferred retirement plans), to be sure that giving is performed in a tax efficient manner. If tax encumbered assets still remain after the selected charitable gift, the estate planning organizer may perform calculations to assess the suitability of incorporating a charitable remainder trust into the plan to receive these assets. The estate planning organizer may calculate any taxes due on the estate based on the original designation.

If the estate is subject to income in respect to decedent tax, and a tax would be due, the estate planning organizer may ask if the user would like to see a charitable option to eliminate the tax. The organizer may then illustrate all tax deferred retirement assets that would be subject to tax, funding a testamentary charitable remainder trust, paying income to heirs for a period of years and then benefiting selected charities. The user could accept the option or adjust it to utilize just a fraction of the retirement assets, reducing but not eliminating the taxes.

If suitable, the estate planning organizer may illustrate this option along with the benefits for consideration of user. In addition, if after the selected charitable gift the estate would be subject to estate taxation, the estate planning organizer may illustrate this liability, and may illustrate charitable options to eliminate this exposure and if charitable options are not selected, display other options to ensure sufficient liquidity exists in the estate for these taxes.

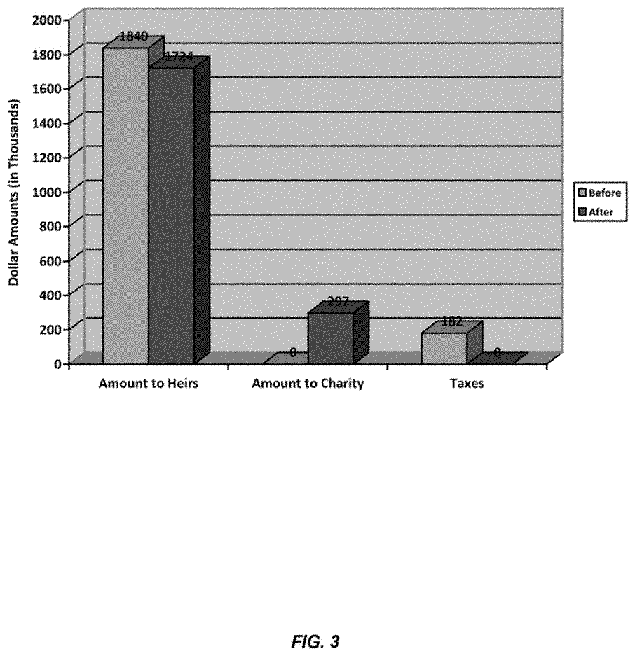

FIG. 3 illustrates an exemplary output that the estate planning organizer may present to the user regarding before and after the estate planning organizer plans with tax considerations.

Further, if any estate taxes are due, the organizer may provide the user an opportunity to see options to eliminate these taxes. Here if tax-deferred retirement assets are available the organizer may first look to eliminate this taxation by recommending a testamentary charitable remainder trust. If these assets are unavailable, or insufficient to eliminate the estate tax, the organizer will illustrate a testamentary charitable lead trust to eliminate the taxation.

In an embodiment, the estate planning organizer (and the above logic and calculations) may be updated for tax law changes. As changes are made, the organizer may contact users (e.g., through email, app notification, and/or other means) that the existing plan is not optimal, and invite the users to revisit the organizer to reevaluate. Also, as legislation changes regarding gifts through tax deferred retirement assets, the organizer may notify impacted individuals based on their ages and size of retirement assets.

The estate planning organizer determines the distribution of the estate based on the received user information in step 126. In an embodiment, the estate planning organizer may determine or aid the user in determining the amount to be distributed to each of the dependents or charities. For example, the estate planning organizer may first determine the amount to be distributed to charity (e.g., based on the user information from step 124) and any amounts to be distributed to other family members or heirs that are not children or dependents (e.g., based on other user information). These amounts can be adjusted from the total estate value. Next, the estate planning organizer may determine the amount that will be distributed to the dependents (e.g., based on the types of dependents and the trust recommended in steps 108 through 122) from the adjusted estate value. In one aspect, each child (and charity child) may receive an equal amount. The amount for each child may be further adjusted by an amount representing an approximated annual income from a trust (e.g., 10%).

The estate planning organizer informs and adjusts the inheritance based on the user information in step 128. Here, the user may be reminded that most inheritances are squandered within 18 months. As the inheritance for each child is calculated, the user may be informed and asked if the child is able to handle such an inheritance responsibility. In an embodiment, if the user decides that a child cannot handle such an inheritance responsibility, the estate planning organizer may recommend that the inheritance be in a form of an income stream (e.g., from a charitable remainder trust). Other children that can handle such inheritance responsibility may be allowed to received their inheritance immediately. In another embodiment, the estate planning organizer may ask the user to reevaluate a child's situation in step 108. For example, the user may be asked to reevaluate a child as one with a special need to guarantee an income stream for life.

The estate planning organizer may also determine that the amount for each child may be too high such that it may be a disincentive to the development of good work habits and reliance on God. For example, if the amount exceeded some adjusted percentage (e.g., adjusted to inflation) of the user's own standard of living at the time when the user was a child, this may be determined to be too high for the user's children. In other embodiments, other standards (e.g., standard of living for children in the area in general, fixed amounts, etc.) may be used as the criteria for this determination.

The estate planning organizer confirms and calculates distribution to the intended charities in step 130.

Once it has been determined how much to leave to charity, the estate is careful to lead the user through decisions on how best to distribute wealth to the charities. Good stewardship involves not only deciding to whom to transfer management, but also how best to transfer management. As discussed above, for distributions to children, the estate planning organizer helps the user examine whether the children are ready to receive a significant inheritance and to steward the wealth wisely. If not, a trust is recommended to protect against this and sometimes a charitable trust is recommended for this purpose. For distribution to charities, sometimes a bequest can be distributed all at once, but in some instances the size of the bequest may be very large compared to the charity's operating budget, making it wise to have the distribution take place in smaller increments over a series of years. In other instances, particularly where there is permanence to the need of the charitable organization, such as caring for the poor, and educating, the best solution may be to make these contributions in the form of an endowment to provide ongoing support. Genesis 41 provides a Biblical illustration of the wisdom of this approach. Here God used Joseph to cause the king of Egypt to order an unprecedented storage of grain against the coming seven years of famine. Through that endowment the people were kept from starvation. The estate planning organizer presents solutions for all of these types of distributions.

The estate planning organizer may ask the user for the list of charitable beneficiaries from the estate. Typically, this may be the same list or a subset of the list that was detailed in step 104 (charities presently supporting). The user may then be asked for the percentage of the total charitable distribution that will be allocated to each charity. For each charitable beneficiary, calculate the amount that they would receive if the estate were settled today, and then go through the following determination:

1. Ask if the charity might be better served by ongoing contributions rather than a one-time distribution 132. This is often viewed as the case when the need that the charity is filling has permanence, such as providing for the poor. If yes, the estate planning organizer may recommend that this portion of the charitable gift be directed to a foundation 136 to provide ongoing support to the name charity through an endowment 136.

2. Ask if the size of the bequests that the charity will receive is very large in relationship with their annual budget 134. If so, the estate planning organizer may recommend that this portion of their charitable distribution be directed through a foundation 136, that would in turn distribute the funds to the desired the charity over a period of years. The estate planning organizer may further determine the period of years that makes the amount reasonable in relationship to the charity's budget.

If it is determined that a foundation would be desirable for one or more of the charities, the estate planning organizer may suggest a specific foundation or foundations to the user that well matches the charities. The estate planning organizer may include price information for the suggested foundations to handle the estate gift along with access to an application (e.g., through hyperlink) to establish and name the fund (account) at the foundation. In an embodiment, the estate planning organizer may generate for the user and transmit to the foundation a request to establish a fund (account), and provide the required information such as type of distributions, information about the recipient charities and name of fund to be established as referenced in the user's estate documents.

In an embodiment, the estate planning organizer may be adapted by an organization providing the organizer with targeted criteria for providing access to various foundations. For example, the organization may have pre-existing relationships with various belief-centric foundations that can administer these gifts consistent with such belief (e.g., various Christian-centric foundations). Some of such foundations may be non-denominational, and therefore may administer these plans in all circumstances for the user; however, the fees for these foundations may be higher. Some of such foundations may be associated with certain denominations, and their rates are often subsidized; however, these foundations would only be applicable for users of the same denomination, and may typically require a minimum distribution to denominational churches/ministries. Based on the user's designation for recipient charitable organizations and other criteria, the estate planning organizer may use these criteria to determine a suitable match for the user.

In one example, the organization providing the estate planning organizer may have relationships with Southern Baptist foundations, both at the individual state level, and the national entity. The estate planning organizer may determine that a user is Baptist (e.g., based on his church—if it is among the charitable entities, or by recognizing any other charitable entities, that the organizer knows to be Baptist). If there is a match, the organizer may first look at the user's state, and if it is among the state foundations that the organizer know would provide a good solution, and if the rates are lower than the national entity, the organizer may recommend the state foundation.

In one aspect, if the user's percentage to Baptist entities is short of the state foundation's requirement, the organizer may notify the user to see if the user prefers to adjust the distribution percentages to qualify. In another aspect, if the state foundation's fees are not lower, the organizer may recommend the national entity; further, if the gift percentage to Baptist entities does not qualify, the organizer may notify the user to consider an adjustment. In both cases, the user's fee may be less than a non-denominational foundation.

In a further embodiment, the organizer may pass certain functionalities performed by the organizer as disclosed herein to client philanthropic entities of the organization. For example, in some circumstances, these philanthropic entities may be able to provide services at better rates than e.g., the foundations. In further instances, the client philanthropic entities may have further foundations that may handle these gifts, at reduced or no fees. For example, the client philanthropic entities may see this as a great opportunity to enhance donor relationships. Therefore, the organizer may further handle customized interactions and functionalities between the client philanthropic entities and the user in a time-limited or on-going basis.

Continuing with example disclosed above, let's imagine that the Baptist user came to the estate planning organizer through Samford University, a Baptist school, and that Samford offers these funds at no cost, provided that the school receive at least 25% of the charitable distribution. In this example, the organizer would be able to suggest Samford as the best solution, if this 25% milestone were met, and illustrate it as the most cost-effective option. If the milestone is not hit, the organizer may mention the school as a great option, so that the user could reassess his distribution, and consider increasing the portion to Samford in order to qualify.

In an embodiment, the estate planning organizer utilizes a logic system and an administrative panel to best represent each client philanthropic entity. The administrative panel may include a list of the client philanthropic entities and their preferences for serving in foundation roles, including minimum gift requirements, and fees for serving in these roles. Based on the origin (e.g., referral link) from which the user accesses the organizer, the organizer system may detect if reached through a client's site, and, if so, pre-list the client's name when asking the user for a listing of potential charitable beneficiaries.

In addition, the organizer may also use this information to present, before any other options, the client's offerings to serve in foundation roles, highlighting preferential rates, and minimum percentage gift requirements. If the user declines the offering of the client that provided access to the organizer, then other options may be provided. The organizer may then search the list of the user's selected charitable beneficiaries for another client in the list that can provide these services. If there is a match, the organizer may present the options offered by the client philanthropic entity; if there are multiple matches, the organizer may work through the list starting with the client philanthropic entity receiving the largest percentage gift. If there are no matches, or if all matches are exhausted, the organizer may detect if the charitable beneficiaries point to any specific denomination. It may do so by referencing the administrative panel listing the nonprofits affiliated will certain denominations. If this is the case, and the denomination offers superior rates, the organizer may surface this option; if not, the organizer may surface a non-denominational option that would work in various cases.

3. If the answer is no to both questions above, the estate planning organizer may determine that a foundation is not needed for the charity's, distribution, and the charity can be named within the estate documents to receive the distribution immediately upon settlement of the estate.

The estate planning organizer informs the user on estate instruments and costs in step 138. The estate planning organizer may explain the utilization/benefit of wills and revocable living trusts for estate documents, and advise on probate costs in their state. The estate planning organizer may also ask for the user's preference between utilizing wills or a revocable living trust and obtain selections for personal representatives, trustees, power of attorneys.

In an embodiment, the estate planning organizer may provide coaching to step the user through these decisions and help the user make informed selections, and provide feedback to avoid unwise selections, such as designating the oldest child to trustee a children's trust.

Appendixes N-1 to N-8 show an exemplary continuous display of interactive guidance provided to the user for selecting a guardian or trustee according to an embodiment. In an embodiment, if the user has a minor child, or a special needs child, the organizer may present the information in Appendixes N-1 to N-8 to help the user designate guardians.

In an embodiment, the estate planning organizer may include automatic communication (e.g., email, SMS, push notification, etc.) follow-up for individuals that are having difficulty making any of these designations. The emails may be tailored to address only needed information, and provide additional assistance to make these determinations, and remind the user that these determinations can always be altered in the future should circumstances change.

In an embodiment, the organizer may send the communications based on one or more of the passages of time (e.g., the knowledge that an individual has not yet completed all the designations in the organizer and/or has not yet purchased estate documents). At certain intervals, communications may be sent to the user to address any missing information.

For example, the first communication may incorporate a technique that was found to be helpful. This communication suggests that the user make list of needed designations, and then write down quickly the first names that come to them for each category. Afterward, it will counsel the user to evaluate the selections but remember that these designations can easily be revised, and any thoughtful designation will be much better than leaving this undone.

If the user still continues to struggle, the organizer may send one or more follow-up communications offering a session with an organization specialist (e.g., an estate specialist) to finalize. The communications may contain a hyperlink that the user can utilize to schedule an appointment with the specialist. Under certain circumstances, a fee will be charged for this appointment.

The estate planning organizer informs the user on suitable professionals in step 140. The information above are summarized and organized for an attorney. The estate planning organizer may further specify the drafting price from one of the network attorneys, and facilitate the user's engagement with the network attorney if this option is selected.

In an embodiment, the estate planning organizer may provide pricing information for attorneys along with user ratings of each attorney, and the opportunity to directly purchase these services. These services may include preparation of rough draft documents based on the information in the organizer, a meeting with the attorney by telephone to review the rough documents, and/or preparing the final documents incorporating any reversions from the review.

In an embodiment, the documents may be developed by each attorney, and may vary from jurisdiction to jurisdiction (e.g., state to state). When an attorney's services are purchased through the organizer, the attorney may receive one or more documents (e.g., electronically or through other means) from the organizer regarding information such as the user's estate inventory and recommendations for estate design customized for the user, so that the attorney may efficiently follow-up with the user.

Appendixes O-1 to O-4 show an exemplary display of a continuous document regarding a user's estate inventory according to an embodiment.

Appendixes P-1 to P-2 show an exemplary display of a continuous document regarding a customized estate design according to an embodiment.

In this way, users may be protected by having a conversation with the attorney, confirming selections and ultimate suitability of all aspects of their estate plan. In an embodiment, the full fee for the service may be authorized upon the user's selection of an attorney, with one half due when the order is placed, and the balance paid upon receipt of final documents. Upon placing the order, the organizer may securely transmit the required information for the attorney to initiate work. In an embodiment, the payment will be made by credit card on the organizer site. In a further embodiment, when the attorney sends final documents, the attorney may go on the site for the organizer to inform that the work has been completed, which would trigger a charge for the balance of the fee.

When documents are ordered, the estate planning organizer may compile statistics regarding intended gifts to various charities. For charities that are clients, the intended gifts may be accumulated, and demonstrated (with or without donor names) on the client portal encouraging the client regarding potential gift activity through their estate planning organizer. In an embodiment, this may be handled using database functions. Whenever documents are purchased, the organizer may populate the database with user name, date, estate size, estate gift size, and gifts to specific charities. For any client, this information may be retrieved as of a particular date, and keep it up for all the additional estate gifts. The user name may be screened from the information received by the client; therefore, only the summary information may be provided, not individual gift listings.

Further, when attorneys send the final documents, the estate planning organizer may send a communication to the user with a short survey for feedback on the attorney's services. The responses may be recorded and reflected in ratings of each attorney. The survey may also include helpful hints and/or instructions for getting documents finalized (e.g., notarization), including assistance in getting this done, such as for church clients, contact information for notaries at the church.

In an embodiment, some time (e.g., approximately three weeks) after final documents are delivered, the estate planning organizer may send another short survey, to follow-up. For example, the survey may first ask the user if the documents have been executed. If the answer is no, the survey may offer various options for assistance, including contact from a professional to provide assistance, e.g., by phone. If the survey response to this question is yes, the survey may continue with some questions regarding the user's satisfaction with the estate planning organizer. It may also ask if the recipient charities can be notified of their estate gifts, so that the charities' can thank the user, and also learn of any special intentions for these gifts. In this case, the organizer may arrange to contact the recipient charities with the relevant information. Further, depending on earlier survey responses, the survey may also inquire the user to see if the organization could convey their endorsement of the estate planning organizer when reporting the user's estate gift to any charity that is not a client, encouraging the charity to also provide the service on their website.

Appendixes L-1 through L-10 show pages from a website for an estate planning organizer according to an exemplary embodiment.

In an embodiment, the estate planning organizer may be further incorporated into the client's website (e.g., for the various organizations). In an aspect, the client's website may include unique page copy for each client and to fit into the body of the client's website page with content from the philanthropic management system. For example, the administrate of each client's website may create the embedded the unique pages from the philanthropic management system to the client's website using the Microsoft iframe tags. Installing to a client's website on a remote server may be similar to videos embedded to websites on remote servers (e.g., by YouTube or Vimeo).

In addition, the content within the estate planning organizer may be customized in a number of ways advantageous to each client. For example, some charities have their own foundations, and can function in the roles disclosed herein above, holding and investing estate gifts for endowments, and for distributions over a period of years. Typically, when charities establish foundations to offer these services directly to donors, the charities offer preferential rates (fees on these funds) in exchange for minimum percentage distributions to the charity. In these instances, the customized estate planning organizer may recommend the clients' foundation to receive estate gifts for qualifying distributions. For distributions that do not qualify, the estate planning organizer may present the opportunity, and associated cost savings, to entice the user to allocate a higher percentage of the gift to the client charity to qualify for the cost savings. Having these gifts pointed to a client's foundation provides tremendous advantages for the client. Also, their donors appreciate the opportunity and cost savings associated with the funds (accounts). The funds provide reason for ongoing conversations with the donors, regarding other services of the foundation, and the opportunity to make current contributions to the fund (account). Further, these estate gifts directed to the client's foundation keep the donors in contact with the client, rather than a third-party, should the donors ever want to change the percentage distribution to each charity, or revise the list of recipient charities.

In an embodiment, when prospective donors (users) register for their personal account, they are taken through a unique estate planning process, from a Biblical perspective. The experience is enhanced through graphics showing customized estate plans, including flow charts depicting amounts to children and charities, and also with invitations for personalized assistance whenever needed.

In an embodiment, client (e.g., administer of the client's website) accessing the philanthropic management system may be provided with an administrative panel. Through this panel, the client can add/edit/delete page copy for all estate planning organizer pages including the addition of client/organization specific photos or images, donor stories and testimonials, and customization of the translation of Biblical references.

In an embodiment, when a user leaves an instance of the estate planning organizer (e.g., through a client's customized website) without finishing, the user may be automatically receive a series of motivational emails generated by the system to encourage the users to return and move forward in completing their documents. These emails may highlight the benefits to finish, ease of the process through the estate planning organizer, and eliminate barriers to finishing. The content of these emails will take into account the sections completed in the estate planning organizer, and in particular those sections skipped or portions left incomplete. The client, through the administrative panel, may edit the content of all of these emails, and the rate or schedule at which they are sent. The client may also receive extensive website statistics to monitor estate planning organizer traffic, along with open rates on and return rates to monitor effectiveness of the motivational emails.

In further embodiment, additional features of the estate planning organizer may include:
Based on information input in the estate planning organizer regarding net worth, ages, type of assets, the estate planning organizer will be able to determine the individuals that are candidates for specific lifetime planned gifts, and generate emails promoting these concepts, with contact forms for additional information, consultations, and invitations to webinars to learn more.
Based on information input, the system may identify needs for other services (wealth management, business succession planning, life insurance) and connect individuals with advisors that share their faith for these services.
For individuals that start but do not finish the estate planning organizer, the system may identify those that are excellent estate gift candidates, such as couples without children, older single individuals that have never married, and individuals with larger estates that exhibit high charitable intent. The system will automatically alert client charity with name and address of these individuals along with a specific charitable estate planning message most likely to draw individuals into more personalized assistance.
The estate planning organizer may be set up to identify users that are influential at the ministry/client, and in positions to make direct referrals of other supporters of the ministry/client. For instance for a church client the system will identify individuals that teach Sunday school classes or Bible studies, and automatically send them information to utilize in their classes, helping them refer others to the estate planning organizer.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

As the foregoing discussion has been presented for purposes of illustration and description, the foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

### Appendix A1: Text of a Home Page for an Embodiment of the Philanthropic Management System of the Present Disclosure Which Gives an Overview of the Turn-Key Internet Based Planned Giving System Offered

“Many claim to provide the best estate planning tools on the Net!But who approaches it from a Biblical perspective?” . . . PCX Does!
PCX is a comprehensive, web based, planned giving service that offers everything for your members to become educated about estate planning from a biblical perspective, informed about tools and techniques of good planned giving, and motivated to take action to create plans appropriate for their families and their ministries. Through planned giving stewardship and estate planning study courses, live interactive online seminars, up-to-date web based information, top quality marketing materials, Christian legal professionals and more, your supporters will get assistance to fulfill their needs . . . And at a price that your ministry can afford!
With the intergenerational transfer of wealth estimated at $41 trillion to $136 trillion and charitable bequests at $6 trillion to $24.8 trillion, presenting planned giving concepts to supporters is crucial.
PCX will help your donors understand the critical issues of providing for their family, reducing taxes and expenses while stewarding their estate for God's glory . . . With privacy, flexibility, control and input from Christian leaders they trust.
An internal/external system any organization can employ to build a broader awareness of the need for financial and estate planning by everyone, not only the very wealthy.
To learn more . . . request a phone call (click here) or attend a PCX seminar (click here)

### What Others are Saying;

As pastors and leaders we are all looking for ways to encourage our congregation to deepen their stewardship of the resources God has entrusted to each one of them. PCX is one of the greatest tools we have found to help our members

### Appendix A2: Text of Text of a Home Page for an Embodiment of the Philanthropic Management System of the Present Disclosure Which Gives an Overview of the Turn-Key Internet Based Planned Giving System Offered (Cont.)

strengthen their stewardship plans to benefit Gods kingdom with all their resources. PhilanthroCorp is a partner you can trust to assist your church in teaching Godly stewardship with integrity! ” Dave Wayman Pastor of Operations at Woodman Valley Chapel “I've been with a total of five different rescue missions, none of whom were doing any planned giving. PCX seems to be the easiest and best way I've ever seen in my career for planned giving to be done at a local rescue mission.” Rev. Billy Fox,

What is claimed is:

1. A method of managing a plurality of web sites, each of the web sites belonging to a corresponding philanthropic entity of a plurality of philanthropic entities, and each of the websites for soliciting philanthropic belief based contributions from a plurality of potential donors, comprising:
(a) storing, by a philanthropic management system, philanthropic information related to beliefs or values of the philanthropic entities relating to situations, circumstances, or events that occur beyond the lifetimes of individuals identified with the philanthropic entities, the philanthropic information being based on Judeo-Christian beliefs or values including directives for stewardship of the Bible;
for each of the websites, performing at least the following (b) through (f) by the philanthropic management system:
(b) for the corresponding philanthropic entity, storing additional information relating to a brand of the corresponding philanthropic entity and associating the corresponding philanthropic information with the additional information, wherein the associating results in corresponding branded information including both the philanthropic information and the additional information, wherein the corresponding branded information visually presents the philanthropic entity as a source for the philanthropic information;
(c) generating a first website, by the philanthropic management system, for accessing the corresponding branded information of the corresponding philanthropic entity and serving contents of the first website as contents of the website belonging to the corresponding philanthropic entity,
wherein the corresponding branded information is accessible to a first potential donor for the corresponding philanthropic entity of the plurality of potential donors via a corresponding link in response to interaction by the potential donor with the website belonging to the corresponding philanthropic entity,
wherein the first potential donor, the corresponding philanthropic entity, and the philanthropic management system are each third parties with respect to each other;
(d) receiving, for the corresponding philanthropic entity, a request by the first potential donor for accessing the corresponding branded information via the corresponding link;
(e) responsive to the receiving of (d), transmitting, for the corresponding philanthropic entity, a response to the request to the first potential donor, wherein the response include the corresponding branded information identifying the corresponding philanthropic entity; and
(f) interactively communicating with the first potential donor through the website belonging to the corresponding philanthropic entity for providing data related to a quantitative financial or economic projection of a potential contribution by the first potential donor to the corresponding philanthropic entity, wherein the data is indicative of a net negative financial or economic impact to the first potential donor, and wherein the potential contribution is based on the Judeo-Christian beliefs or values including the directives for stewardship based on the Bible,
wherein communications for the interactively communicating in (f) is private and secure between the potential donor and the philanthropic management provider,
wherein the method further comprises performing at least the following (g) through (i):
(g) receiving, via the Internet, from the first potential donor, contribution-related information for assisting the first potential donor in defining an initial agreement for contributing to one or more of the philanthropic entities selected by the first potential donor, wherein the contribution-related information includes at least one from a group consisting of: information for preparing a will, information for preparing a revocable living trust, information for preparing a bypass trust, information for preparing a testamentary charitable remainder trust, and information for preparing a children's trust;
(h) providing the first potential donor with contact information to one or more individuals having professional knowledge in estate planning in charitable giving to the philanthropic entities selected by the first potential donor, wherein the individuals are selected by the philanthropic management system based upon information pertaining to beliefs or values of the individuals relating to situations, circumstances, or events that occur beyond the lifetime of the individuals, and wherein the first potential donor is able to select one of the individuals for assistance in defining initial agreement; and
(i) for the first potential donor, transmitting via the Internet at least a portion of the contribution-related information to the one individual selected by the first potential donor, wherein the contribution-related information is utilized to prepare the initial agreement;
wherein for the first potential donor, the potential donor executes the initial agreement thereby becoming a donor, and
wherein the interactively communicating in (f) comprises performing at least the following:
(f-1) notifying, through the website belonging to the corresponding philanthropic entity, the first potential donor of stewardship decision making consistent with the Judeo-Christian beliefs or values;
(f-2) receiving from the first potential donor, by the philanthropic management system through the website belonging to the corresponding philanthropic entity, information on dependents; and
(f-3) determining a distribution of an estate of the first potential donor based at least on the information on the dependents, wherein the distribution includes at least the potential contribution to the corresponding philanthropic entity.

2. The method of claim 1, further including restricting or filtering at least one contact information from being provided to the first potential donor, wherein the at least one contact information is for an individual that expressly states or advocates acts that are not consistent with the beliefs or values of the philanthropic entities selected by the first potential donor.

3. The method of claim 1, wherein for a first and a second of the selected philanthropic entities, a different portion of the stored philanthropic information is transmitted to the first potential donor.

4. The method of claim 1, further including transmitting to one the potential donor contribution diversification or allocation information aggregately collected from other donors to the philanthropic entities, wherein for the potential donor, the contribution diversification or allocation information transmitted thereto is obtained from contribution diversification or allocation information collected from at least some of the other donors identified in determining a similarity between the at least some of the other donors and the first potential donor.

5. The method of claim 1, further including after the first potential donor executes the corresponding initial agreement, specifying at least one rule or constraint for changing contribution amounts between a first and a second of the selected philanthropic entities, wherein the at least one rule is dependent upon a total amount or projected amount in a trust fund for contributing to the first and second selected philanthropic entities, the trust fund being one of the revocable living trust, the bypass trust, the testamentary charitable remainder trust, and the children's trust.

6. The method of claim 1, further including after the first potential donor executes the corresponding initial agreement, specifying at least one rule or constraint for changing a contribution to at least one of the corresponding one or more philanthropic entities, wherein the at least one rule determines a contribution to the at least one of the corresponding one or more philanthropic entities according to an amount of funds received by the at least one corresponding philanthropic entity during a predetermined time interval.

7. The method of claim 1, further including, after the first potential donor executes the corresponding initial agreement thereby becoming a donor, adjusting contributions of the donor between two of the corresponding one or more philanthropic entities, wherein the adjusting includes performing a statistical simulation for determining relative contributions to a first and second of the corresponding one or more philanthropic entities over time, wherein economic fluctuations in the future are approximated using economic fluctuations in the past.

8. The method of claim 1, further including, adjusting at least one contribution by the donor to one of the corresponding one or more philanthropic entities selected by the donor, wherein the adjustment of the contribution is dependent upon an annual income of the one philanthropic entity.

9. The method of claim 1, wherein the initial agreement includes contributions and planning to the benefit of one or more of: a spouse, a child, and a ministry, wherein the contributions and planning is consistent with the directives for stewardship of the Bible.

10. The method of claim 1, wherein the initial agreement includes planning related to one or more of: a durable general power of attorney, a health care power of attorney, a living will or directive to physicians, wherein the planning is consistent with the directives for stewardship of the Bible.

11. The method of claim 1, wherein the initial agreement includes planning related to guardianship of a child of the donor, wherein the planning is consistent with the directives for stewardship of the Bible.

12. The method of claim 11, wherein the planning includes selecting a guardian for the child based on one or more of: spiritual values of the guardian and location of the guardian.

13. The method of claim 11, wherein the initial agreement includes planning of a trust for the child, wherein the planning of the trust is consistent with the planning related to the guardianship and the directives for stewardship of the Bible.

14. The method of claim 1, wherein the corresponding link is provided on a presentation transmitted to the first potential donor from a different website identified with and operated by the each philanthropic entity, wherein the corresponding link is used by the first potential donor to access to the corresponding branded information for the corresponding philanthropic entity.

15. The method of claim 1, wherein the dependents include one or more of an older dependent, and a child that is a minor or has special needs.

16. The method of claim 1, wherein the dependents include one or more child dependents, wherein each of the child dependents has equal distribution from the estate, and wherein the corresponding philanthropic entity is treated as a child dependent.

17. The method of claim 1, wherein the potential contribution is an on-going contribution based on one or more of needs of the corresponding philanthropic entity or the potential contribution being a proportionally large contribution to a typical size of contribution to the each philanthropic entity.

18. The method of claim 17, wherein the on-going contribution is in the form of a foundation.

19. The method of claim 1, wherein the interactively communicating in (f) further comprises (f-4) adjusting the distribution to at least one of the dependents based on harm based analysis of the distribution as consistent with the Judeo-Christian beliefs or values.

20. A method of managing a plurality of websites, each of the websites belonging to a corresponding philanthropic entity of a plurality of philanthropic entities, and each of the websites for soliciting philanthropic belief based contributions from a plurality of potential donors, comprising:
(a) storing, by a philanthropic management system, philanthropic information related to beliefs or values of the philanthropic entities relating to situations, circumstances, or events that occur beyond the lifetimes of individuals identified with the philanthropic entities, the philanthropic information being based on Judeo-Christian beliefs or values including directives for stewardship of the Bible;
for each of the websites, performing at least the following (b) through (f) by the philanthropic management system:
(b) for the corresponding philanthropic entity, storing additional information relating to a brand of the corresponding philanthropic entity and associating the corresponding philanthropic information with the additional information, wherein the associating results in corresponding branded information including both the philanthropic information and the additional information, wherein the corresponding branded information visually presents the philanthropic entity as a source for the philanthropic information;
(c) generating a first website, by the philanthropic management system, for accessing the corresponding branded information of the corresponding philanthropic entity and serving contents of the first website as contents of the website belonging to the corresponding philanthropic entity,
wherein the corresponding branded information is accessible to a first potential donor for the corresponding philanthropic entity of the plurality of potential donors via a corresponding link in response to interaction by the potential donor with the website belonging to the corresponding philanthropic entity,
wherein the first potential donor, the corresponding philanthropic entity, and the philanthropic management system are each third parties with respect to each other;
(d) receiving, for the corresponding philanthropic entity, a request by the first potential donor for accessing the corresponding branded information via the corresponding link;
(e) responsive to the receiving of (d), transmitting, for the corresponding philanthropic entity, a response to the request to the first potential donor, wherein the response include the corresponding branded information identifying the corresponding philanthropic entity; and
(f) interactively communicating with the first potential donor through the website belonging to the corresponding philanthropic entity for providing data related to a quantitative financial or economic projection of a potential contribution by the first potential donor to the corresponding philanthropic entity, wherein the data is indicative of a net negative financial or economic impact to the first potential donor, and wherein the potential contribution is based on the Judeo-Christian beliefs or values including the directives for stewardship based on the Bible, wherein communications for the interactively communicating in (f) is private and secure between the potential donor and the philanthropic management provider, and
wherein the method further comprises performing at least the following (g) through (i):
(g) receiving, via the Internet, from the second potential donor, contribution-related information for assisting the second potential donor in defining an initial agreement for contributing to one or more of the philanthropic entities selected by the second potential donor, wherein the contribution-related information includes at least one from a group consisting of: information for preparing a will, information for preparing a revocable living trust, information for preparing a bypass trust, information for preparing a testamentary charitable remainder trust, and information for preparing a children's trust;
(h) providing the second potential donor with contact information to one or more individuals having professional knowledge in estate planning in charitable giving to the philanthropic entities selected by the second potential donor, wherein the individuals are selected by the philanthropic management system based upon information pertaining to beliefs or values of the individuals relating to situations, circumstances, or events that occur beyond the lifetime of the individuals, and wherein the second potential donor is able to select one of the individuals for assistance in defining initial agreement; and
(i) for the second potential donor, transmitting via the Internet at least a portion of the contribution-related information to the one individual selected by the first potential donor, wherein the contribution-related information is utilized to prepare the initial agreement;
wherein for the second potential donor, the potential donor executes the initial agreement thereby becoming a donor,
wherein the interactively communicating in (f) comprises performing at least the following:
(f-1) notifying, through the website belonging to the corresponding philanthropic entity, the first potential donor of stewardship decision making consistent with the Judeo-Christian beliefs or values;
(f-2) receiving from the first potential donor, by the philanthropic management system through the website belonging to the corresponding philanthropic entity, information on dependents; and
(f-3) determining a distribution of an estate of the first potential donor based at least on the information on the dependents, wherein the distribution includes at least the potential contribution to the corresponding philanthropic entity.

21. A system for managing a plurality of websites by a philanthropic management provider, each of the websites for soliciting philanthropic belief based contributions, comprising:
(a) a computer store containing data for philanthropic information related to beliefs or values of a plurality of philanthropic entities relating to situations, circumstances, or events that occur beyond the lifetimes of individuals identified with the philanthropic entities, the philanthropic information being based on Judeo-Christian beliefs or values including directives for stewardship of the Bible,
wherein the computer store further comprises data, for each of the websites, additional information relating to a brand of a corresponding philanthropic entity of the plurality of philanthropic entities, for visually presenting the corresponding philanthropic entity as a source for the philanthropic information,
wherein each of the websites belongs to the corresponding philanthropic entity, and wherein the potential donor, the corresponding philanthropic entity, and the philanthropic management provider are each third parties with respect to each other; and
(b) a computer server at the philanthropic management provider, wherein the computer server is coupled to the computer store and programmed to:
(i) receive, from a web browser of the potential donor, a request by the potential donor for the additional information via the corresponding link;
(ii) identify the corresponding philanthropic entity based on the corresponding link;
(iii) in response to the identification of the corresponding philanthropic entity, retrieve the stored data for the corresponding branded information; and
(iv) generate and transmit a response to the request to the potential donor, wherein the response includes a webpage that displays a combination of the philanthropic information and the additional information, wherein the combination is visually presented as corresponding branded information including both the philanthropic information and the additional information such that corresponding philanthropic entity as identified as a source for the corresponding branded information including the philanthropic information; and
(v) interactively communicate with the potential donor through the website for providing data related to a quantitative financial or economic projection of a potential contribution by the potential donor to the corresponding philanthropic entity, wherein the data is indicative of a net negative financial or economic impact to the potential donor, wherein the potential contribution is based on the Judeo-Christian beliefs or values including the directives for stewardship based on the Bible,
wherein communications for the interactively communicate in (v) is private and secure between the potential donor and the philanthropic management provider, and
wherein the interactively communicate in (v) comprises at least the following:
(v-1) notify, through the website belonging to the corresponding philanthropic entity, the potential donor of stewardship decision making consistent with the Judeo-Christian beliefs or values;
(v-2) receive from the first potential donor, by the philanthropic management system through the website belonging to the corresponding philanthropic entity, information on dependents; and
(v-3) determine a distribution of an estate of the potential donor based at least on the information on the dependents, wherein the distribution includes at least the potential contribution to the corresponding philanthropic entity.
